(19) United States
(12) Patent Application Publication
(10) Pub. No.: US 2003/0021341 A1
(43) Pub. Date: Jan. 30, 2003

(54) Method of effective backwards compatible ATSC-DTV multipath equalization through training symbol induction

(76) Inventors: Armando J. Vigil, Altamonte Springs, FL (US); Madjid A. Belkerdid, Casselberry, FL (US)

Correspondence Address: ARMANDO J VIGIL, PH.D., P.E., P.O. BOX 162997, ALTAMONTE SPRINGS, FL, 32716-2997, US

(21) Appl. No.: 09/840,481

(22) Filed: Apr. 23, 2001

Related U.S. Application Data
(60) Provisional application No. 60/201,537, filed on Apr. 24, 2000.

(51) Int. Cl. H04N 7/12

(52) U.S. Cl. 375/240.01; 375/240.26

(57) ABSTRACT

This invention enables improved reception of ATSC terrestrial broadcast digital television signals. ATSC DTV is a standard of the Advanced Television Systems Committee (ATSC) for the terrestrial broadcast of digital television. ATSC DTV broadcast signals are subject to impairment due to multipath. Improved radio reception in multipath is possible when substantial reference components are transmitted as a component of the transmitted radio. However, the introduction of new signal components to the ATSC DTV broadcast signal represents a modification to the standard which weaken the benefits of standardization. This invention resolves this dilemma by carefully introducing data components into the data multiplex in a form compatible with the ATSC DTV standard. Data components are chosen so as to induce a substantial repeating reference component into the ATSC DTV modulation waveform. The induced reference waveform enables clear reception in multipath while the integrity of the standard is preserved.

### BACKGROUND OF THE INVENTION

The present invention relates to Digital Television (DTV) in general and specifically to the Advanced Television Systems Committee (ATSC) standard for terrestrial broadcast television in the United States.

The ATSC DTV standard was determined by the “Grand Alliance” and subsequently accepted by the broadcast community, the consumer electronics industry and the regulatory infrastructure. The regulatory infrastructure has mandated a strictly scheduled transition for the transition of terrestrial broadcast television in the United States from the National Television System Committee (“NTSC” or “analog”) standard to the ATSC (“digital”) standard. At the time of this disclosure, a significant investment is in place, on behalf of the broadcast industry, in terms of substantial progress in cooperation with the planned transition. Similarly, many consumers have purchased ATSC television receiver equipment in the form of new ATSC-system compliant DTV television sets and in the form of DTV television set-top converters.

However, the ATSC standard, in its present form, is deficient in its susceptibility to multipath. It is well known that in side-by-side comparisons, ATSC (new digital system) reception is often inferior to NTSC (conventional analog system) reception. Additionally, ATSC mobile reception is observed to suffer more substantial degradation due to multipath than NTSC mobile reception. It is also well known that signal strength and signal-to-noise ratio (SNR) are not at issue. Unanticipated inferior reception manifests itself at high levels of received signal power and at high receiver signal-to-noise ratios (SNR's). This fact, coupled with spectral analysis of received ATSC DTV signals, point directly to multipath as the cause of inferior reception.

Various inventors have disclosed significant work in the area of DTV reception. Included in this work is Park et al. in 5,592,235, issued Jan. 7, 1997, which describes means of efficiently combining reception, appropriate to terrestrial broadcast and to cable broadcast, both in a single receiver. Also included in this work is Oshima in 5,802,241, issued Sep. 1, 1998, which describes a plurality of modulation components modulated by a plurality of signal components.

The use of decision-feedback equalizers (DFE) in digital demodulation is a matter of prior art. Unfortunately, DFE equalization is not suitable for enabling the initial acquisition of digital modulation severely distorted by multipath-induced intersymbol interference. For this purpose, a reference waveform or reference sequence is typically introduced. The use of a reference sequence equalizer is considered by Lee in 5,886,748, issued Mar. 23, 1999, which describes in very general terms the use of a reference sequence for equalizing “GA-HDTV” signals. Unfortunately, the cited work does not address the multipath issues relevant to ATSC DTV reception. Neither does this work address the compatibility between the referenced “training sequence” with the existing ATSC DTV standard. Nor does the cited work address the relevance or appropriateness of the referenced training sequence and equalization method to VHF and UHF multipath, whose impact on ATSC DTV reception was discovered after the fact of the cited work.

Also of importance to the present introduction of terrestrial ATSC DTV in the United States is the work by Limberg in 5,923,378, issued Jul. 13, 1999. This work addresses NTSC-to-DTV interference issues relevant to the DTV transition plan in effect in the United States. Also of interest is the work by Gans et al. in 5,943,372, issued Aug. 24, 1999, which introduces the combination of diversity transmission with complementary forward error correction. Unfortunately, none of the cited works constitutes an effective remedy in the context of ATSC-standard terrestrial broadcast DTV.

### BRIEF SUMMARY OF THE INVENTION

The present invention addresses the strategy of enabling “reference” or “training” “sequence” or “waveform” equalization by introducing an equalizer training waveform compatibly with the present ATSC DTV standard for terrestrial broadcast DTV in the United States. A training waveform is induced into the ATSC DTV modulation waveform by introducing training sequence placeholders onto the ATSC DTV multiplex and transport. Subsequent processing yields modulation training suitable for allowing and tailored to enabling the adaptive equalization processes required at the receiver to address VBF and UHF multipath. The necessary transmission signal processing is accomplished with no hostile effects in terms of backward compatibility with pre-existing legacy ATSC DTV receivers. The training waveform as such is induced specifically to enable training-waveform-based equalization adequate and necessary to address multipath-induced intersymbol interference otherwise known to be catastrophic to ATSC DTV reception.

ATSC DTV modulation is preserved and ATSC DTV multiplex and transport remain compatible with the existing ATSC DTV standard. As such, the existing ATSC DTV infrastructure is compatible with the disclosed ATSC DTV multipath solution. Every existing ATSC DTV receiver continues to function as it has functioned before. Retrofit of preexisting consumer ATSC DTV receiver equipment is unnecessary. However, the production of new consumer ATSC DTV receiver equipment is made possible, through this disclosure, with minimum economic disruption. The practical cost and complexity of the necessary transmission equipment upgrade is minimized through the exploitation of the backwards-compatible ATSC DTV multiplex and transport training sequence induction technique disclosed. Substantial and significant advantage with respect to multipath equalization processing is enabled through the exploitation of the backward compatible ATSC DTV modulation and transmission training waveform induction technique disclosed.

### BRIEF DESCRIPTION OF THE DRAWINGS

FIG. 1 is a general block diagram of the ATSC DTV transmission system i.a.w. (in accordance with) the ATSC DTV standard [ATSC Digital Television Standard, ATSC document number A/53].

FIG. 2 illustrates the ATSC DTV modulation frame i.a.w. the same standard.

FIG. 3 is a conceptual illustration of multipath.

FIG. 4 is a simplified block diagram of the continuous-time modulator and channel model.

FIG. 5 is a block diagram illustrating an equivalent time-sampled modulator and channel model.

FIG. 6 is a block diagram of an adaptive blind equalizer.

FIG. 7 is a block diagram of an adaptive decision-feedback equalizer.

FIG. 8 is a block diagram of an adaptive training waveform equalizer.

FIG. 9 is a simplified block diagram of the ATSC DTV transmission and reception systems.

FIG. 10 is a simplified block diagram of ATSC DTV transmission and reception systems retrofitted for standard-noncompliant training waveforms.

FIG. 11 is a simplified block diagram of ATSC DTV transmission and reception systems retrofitted for backwards-compatible induced equalizer training symbols.

FIG. 12 is a general block diagram of the ATSC DTV transmission system i.a.w. the ATSC DTV standard [ATSC Digital Television Standard], highlighting the data interleaving process in the presence of training sequence induction data.

FIG. 13 illustrates the introduction of induction packet sequences at the rate of 1 induction packet per 13 ATSC DTV multiplex packets.

FIG. 14 illustrates the ATSC DTV byte interleave process i.a.w. the ATSC DTV standard [ATSC Digital Television Standard].

FIG. 15 illustrates an example where an interleaved frame has been formed by introducing 1 induction packet per 6 ATSC DTV multiplex packets.

FIG. 16 illustrates the ATSC DTV TCM byte interleave process i.a.w. the ATSC DTV standard [ATSC Digital Television Standard].

FIG. 17 illustrates the ATSC DTV TCM bit interleave process i.a.w. the ATSC DTV standard [ATSC Digital Television Standard].

FIG. 18 illustrates the ATSC DTV TCM encode process i.a.w. the ATSC DTV standard [ATSC Digital Television Standard].

### DETAILED DESCRIPTION OF THE INVENTION

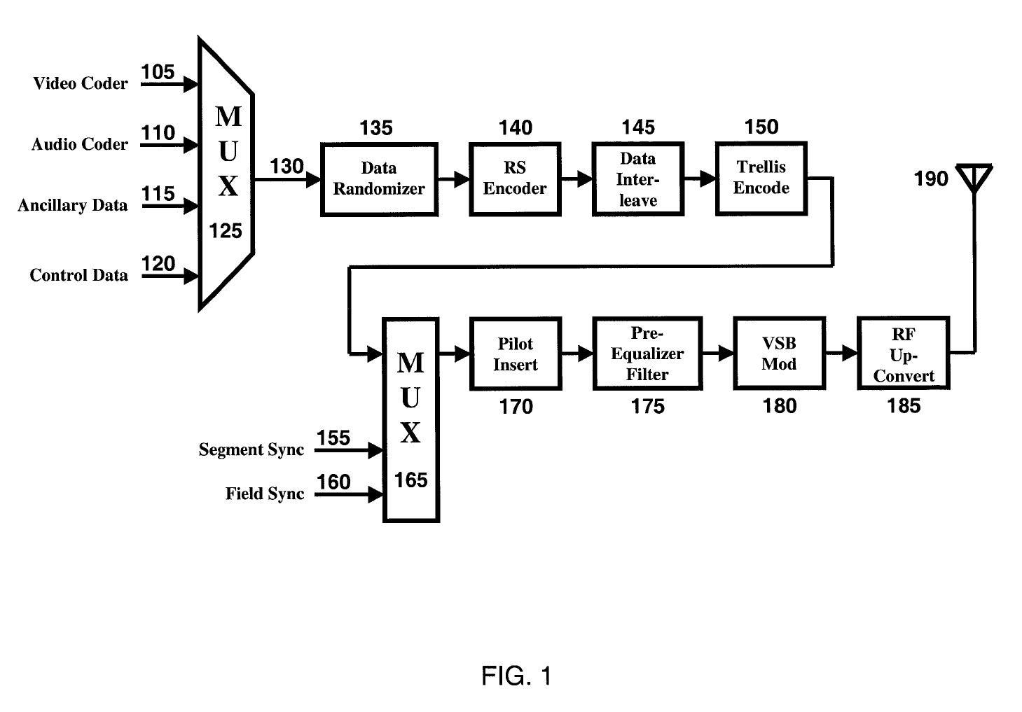

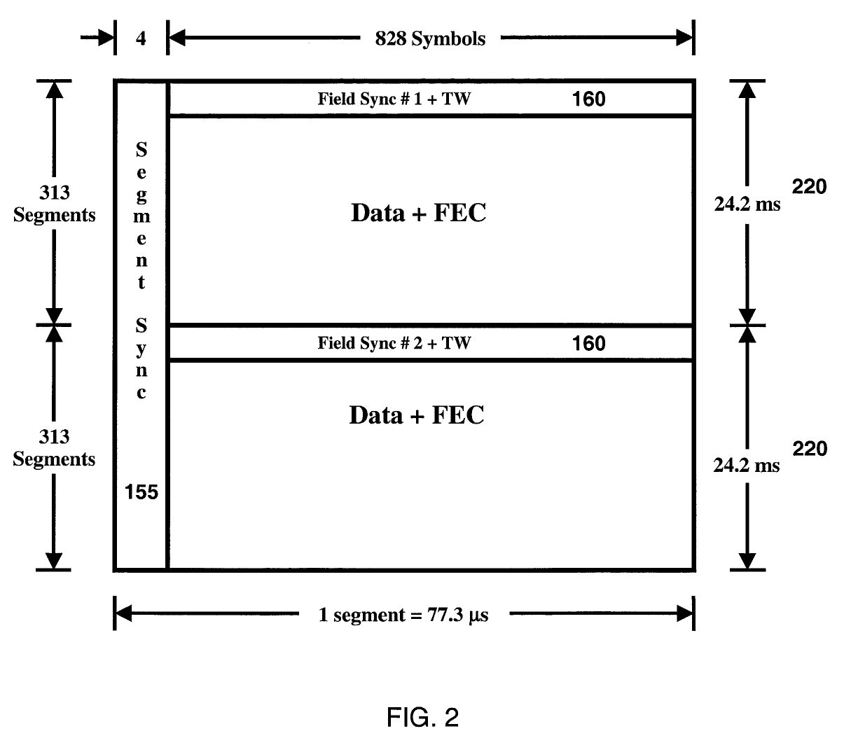

The ATSC DTV transmission system is illustrated in FIG. 1. The transmission system multiplexes 125 various components of the broadcast program, including video 105, audio 110, data 115 and control information 120. The service multiplex stream 130 is randomized 135, Reed-Solomon encoded 140, byte-interleaved 145 and TCM encoded 150 in preparation for modulation. Modulation consists of the introduction 165 of segment sync 155 and field sync 160, adddition of a pilot 170, followed by preequalization 175, VSB modulation 180 and RF upconversion 185. The modulation format is commonly described in terms of the “ATSC DTV modulation frame” illustrated in FIG. 2.

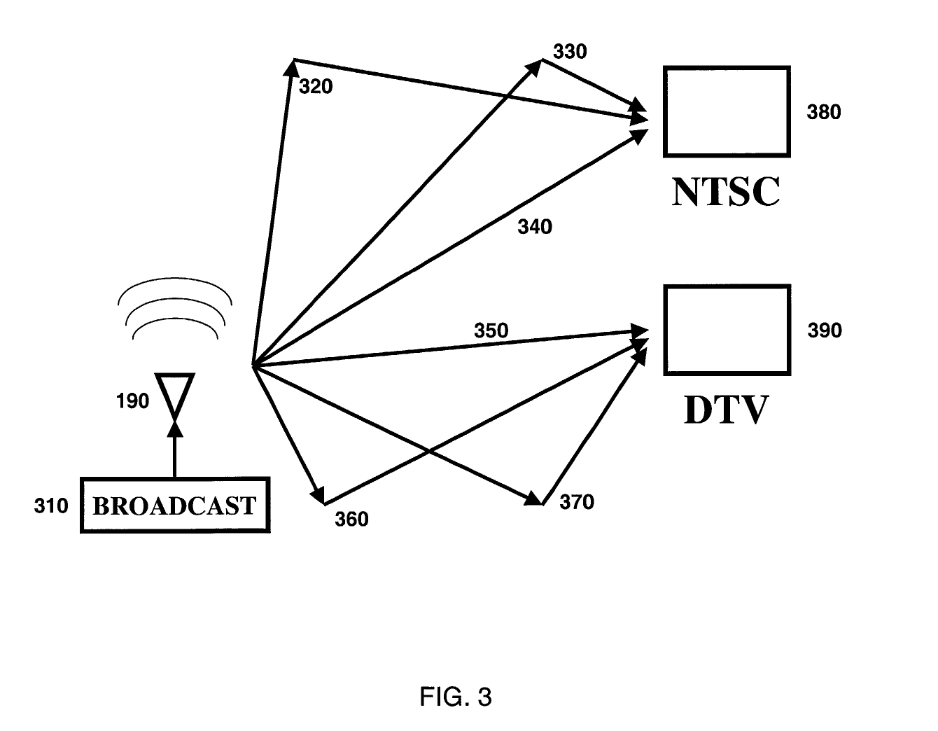

The foremost weakness of the ATSC DTV standard for terrestrial broadcast digital television is its susceptibility to multipath. FIG. 3 illustrates the dilemma caused by multipath. The propagation path from the broadcast transmitter site 310 to any given receiver sight (“NTSC” 380 or “DTV” 390) may involve any whole number (zero or more) of propagation paths 320, 330, 340, 350, 360 and 370. Each independent or unique propagation path 320, 330, 340, 350, 360 and 370 has independent or unique amplitude, delay and phase characteristics. The customary consumer antenna does not distinguish from multiple paths. Such a process (multiple antennas or phased arrays) is beyond the capability of conventional consumer electronic equipment customary for use in television reception. Consequently, each received signal from each of multiple paths 320, 330, 340, 350, 360 and 370 contributes either constructively or destructively to each other received signal from each other associated path 320, 330, 340, 350, 360 and 370. It is more likely that two or more multiple paths 320, 330, 340, 350, 360 and 370 add destructively rather than constructively. The complication of multiple additive amplitude, phase and delay responses yields a received signal subject to unpredictable linear time and frequency distortion or self-interference.

Again in FIG. 3, on the right side of the figure, an NTSC (conventional analog) receiver 380 is shown above and a DTV (ATSC standard digital) receiver 390 is shown below. This aspect of FIG. 3 serves to illustrate the present dilemma faced by the broadcast industry. In the case of the conventional analog “NTSC” system 380 depicted above, multipath manifests itself in terms of analog interference. The resulting program distortion manifests itself primarily as “ghosting.” “Ghosts” of the analog image consist of superimposed copies of the intended picture appearing over the intended picture in the video display. Ghosts are commonly observed in terrestrially received NTSC video images. This video image ghosting is sometimes tolerable to the viewer, as ghosting may or may not be substantially significant in terms of image degradation. This is in contrast to the multipath distortion effects commonly observed in new digital “ATSC” 390 DTV reception described. With respect to the ATSC modulation waveform, multipath manifests itself in intersymbol interference. Intersymbol interference is known, in the ATSC system, to cause catastrophic failure. There is no “ghosting” or “graceful degradation.” The signal is simply lost (SNR “cliff effect”) or it is never acquired (when intersymbol interference violates demodulation signal acquisition thresholds). In the former case, the visible result is image “freezing” or “deresolution” due to loss of data. In the former case, the audible result is muting (loss of audio). In the latter case, the visible result is a blank screen and silent audio. Based on these observations, and on their corresponding frequency of occurrence, one skilled in the art of television reception arrives at the conclusion that the ATSC DTV standard format, in its present form, constitutes a service downgrade with respect to reception reliability.

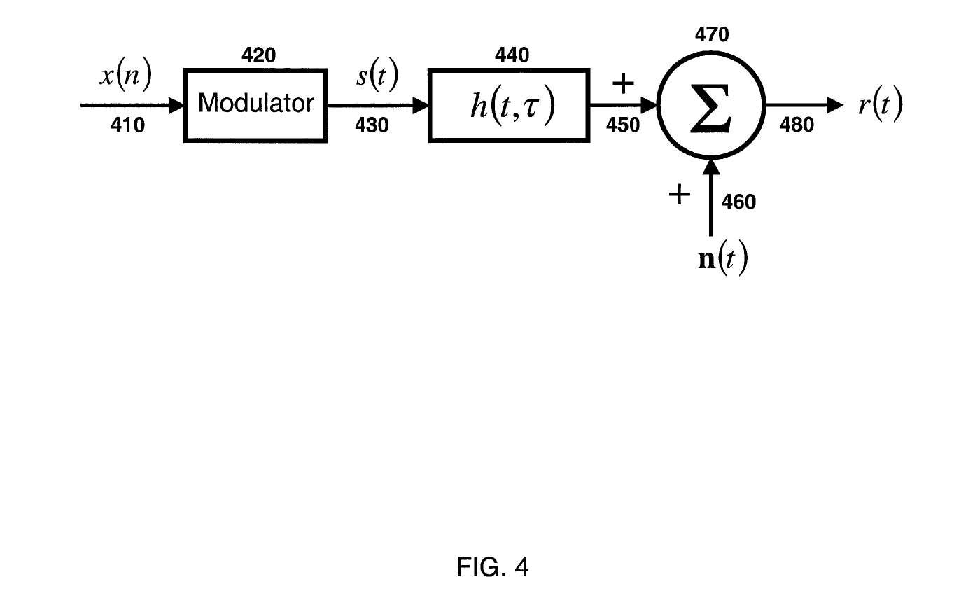

Multipath may be modeled in continuous time as a linear convolutional process h(t,τ) 440 as shown in FIG. 4. In this figure, the symbol sequence x(n) 410 is applied to 11 the modulator 420, producing a modulation waveform s(t) 430. The propagation channel is represented by the convolutional process h(t,τ) 440 and the additive 470 noise process n(t) 460. The resulting signal r(t) 480 is received at the ATSC DTV receiver.

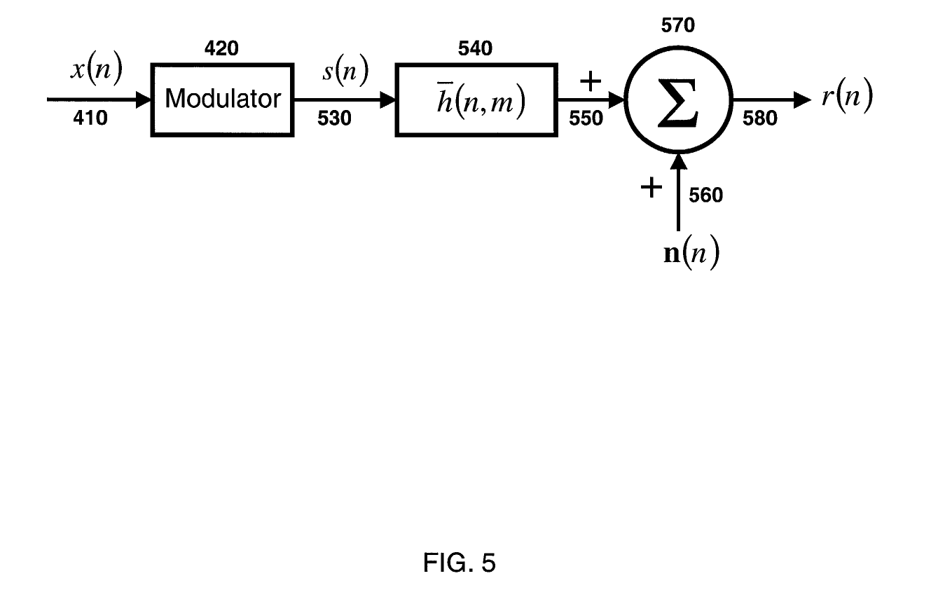

The modulation and channel propagation processes lend themselves to time-sampled representation as shown in FIG. 5. In this figure, the modulation signal s(n) 530 is modeled as a time-sampled waveform in time index n. Although the same time index is used for the symbol sequence x(n) 410, it is important to note that “N×sampling” (“N-times sampling”) is common to digital signal processing relevant to both the transmission and reception systems. The use of the same time index for both waveforms is not intended to preclude the use of “N×sampling” in this application. The modulation symbol sequence x(n) 410 in time index n is to be thought of as adhering to the identical “N×sampling” process and consisting of repeated sets of “N-1” “zero” samples interspersed with single symbol states.

Nor should the absence of complex notation throughout this application be misconstrued as to preclude the use of complex sampling. Complex sampling is both anticipated and expected, omitted in this application merely for the sake of simplifying the disclosure.

In FIG. 5, the same linear convolutional multipath response h(t,τ) 440 is modeled as a time-sampled vector process \overline{h}(n, m) 540 where n is the time index and m is the time-response index, indicating a “vector” sampled-time response in m at every time sample n. Lastly, channel noise n(n) 560 is added 570 on a sample-by-sample basis to yield the received time-sampled waveform r(n) 580.

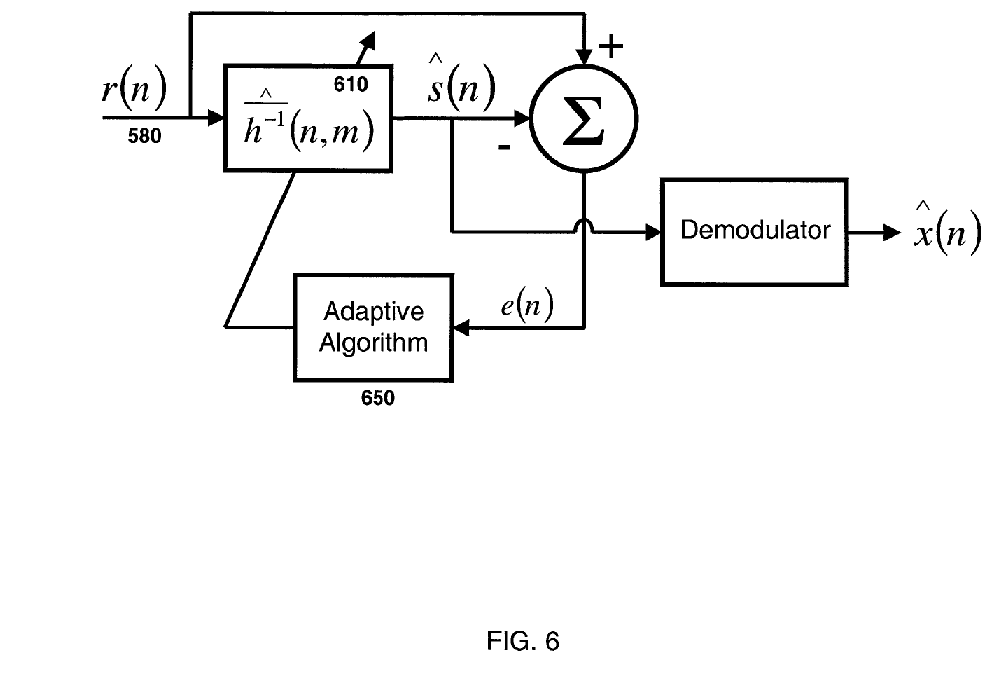

This time-sampled model is applied to the drawings, which illustrate prior art applied to ATSC DTV equalization. FIG. 6 illustrates a blind equalizer used to adaptively converge 650 on a sufficiently accurate approximation

$$\hat{\overline{{h}^{- 1}}} ( n , m )$$

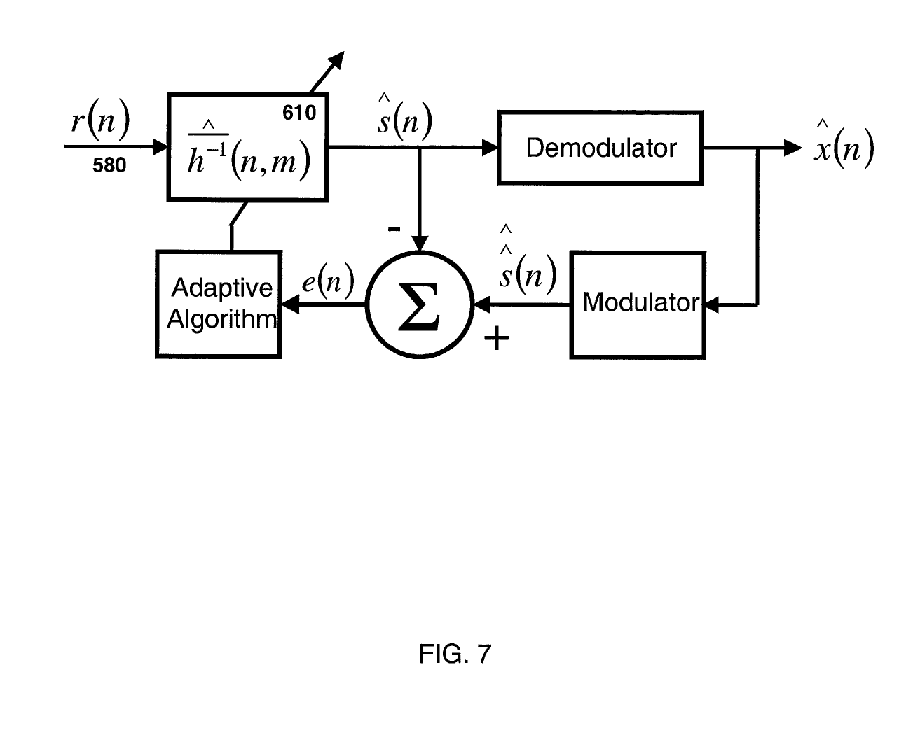

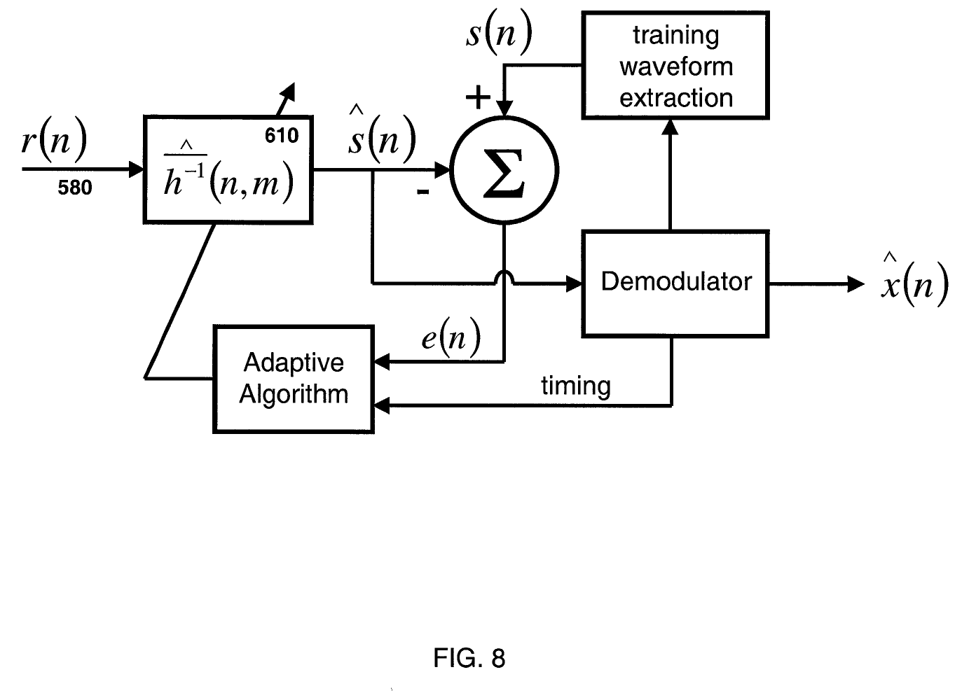

(n,m) 610 of the inverse \overline{h⁻¹}(n,m) of the channel response \overline{h}(n,m) 540. FIG. 7 illustrates the decision feedback equalizer applied to the same purpose. A training waveform equalizer is illustrated in FIG. 8. In all cases, prior art has failed to produce a suitable equalizer and/or demodulator capable of reliably receiving the conventional ATSC DTV terrestrial broadcast waveform in the presence of significant multipath.

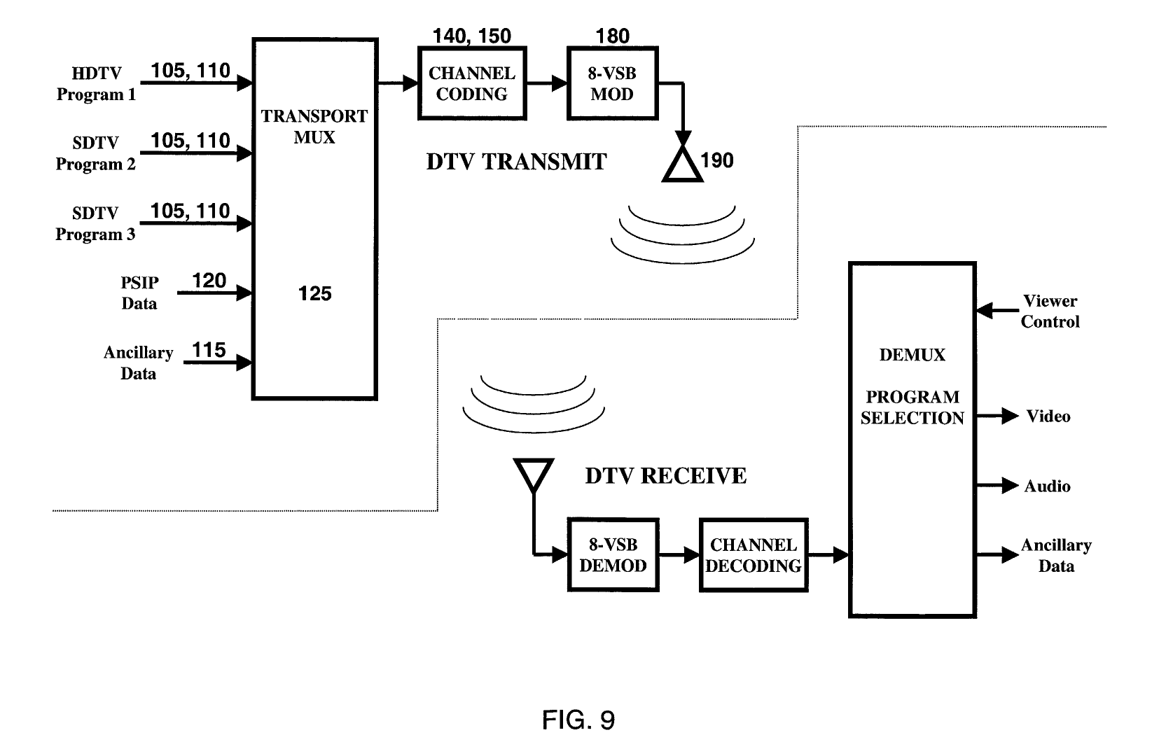

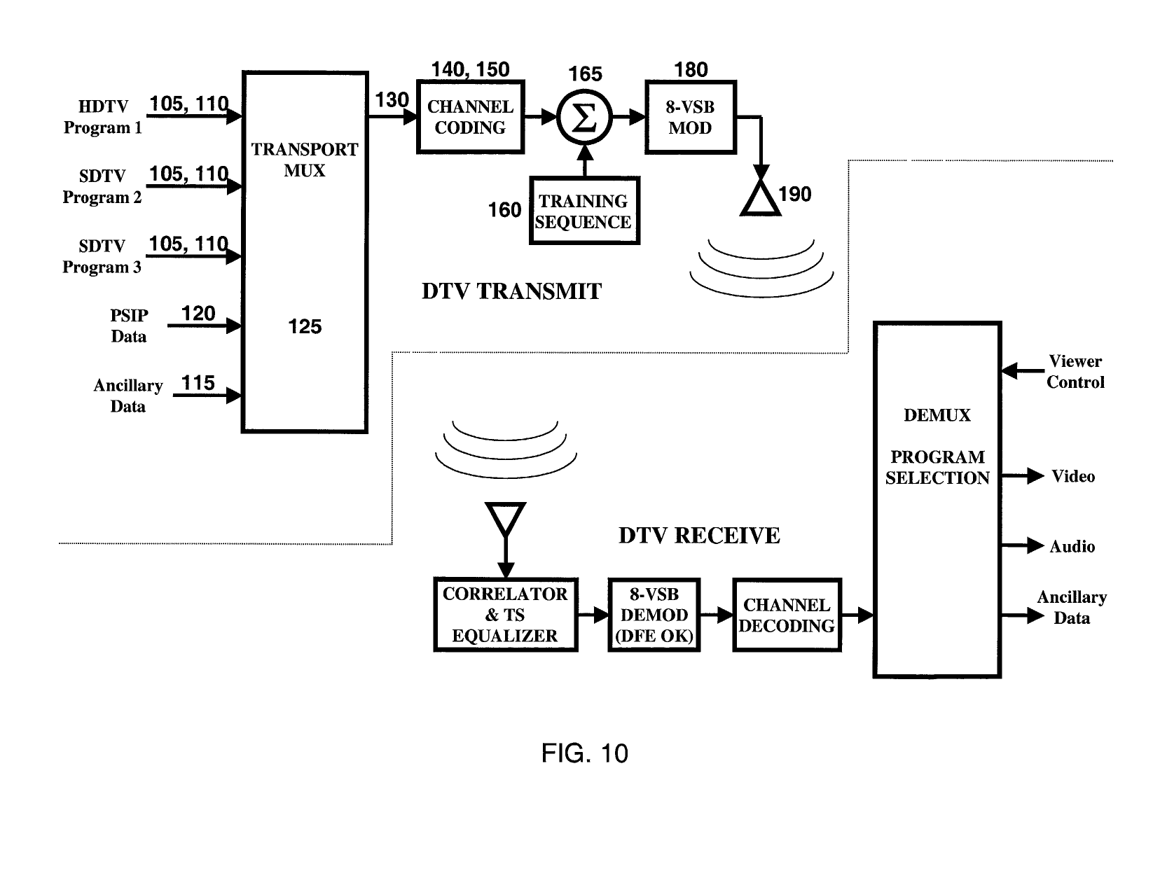

An inherent weakness of the ATSC DTV standard system, illustrated in the simplified block diagram of FIG. 9, is the 24.2 ms interval 220 between successive training waveforms 160 in the modulation frame, illustrated in FIG. 2. This training waveform interval 220 is not short enough to enable receivers to accurately track temporal multipath variations quickly enough to yield effective reception. One possible solution is to explicitly introduce additional training waveform components 160 more frequently into the modulation frame. The required system modifications are illustrated in FIG. 10. Such a solution would be politically detrimental in that it would render existing ATSC DTV transmission and reception equipment obsolete. As such, the direct addition of supplemental training waveform components is economically untenable.

An economically viable solution requires “backward compatibility” with existing receivers. Such a solution may be identified by the following marks.

1. Enables continuous reliable viewing in the presence of significant multipath channel impairments

2. “Significant multipath channel impairments” to include “ghosts” generated by reflections and/or obstructions moving at 100 kilometers per hour (>60 MPH) with respect to reception equipment

3. This while every preexisting legacy ATSC DTV receiver

a) receives the same signal

b) to the extent that it can be received in the absence of any transmission waveform modifications

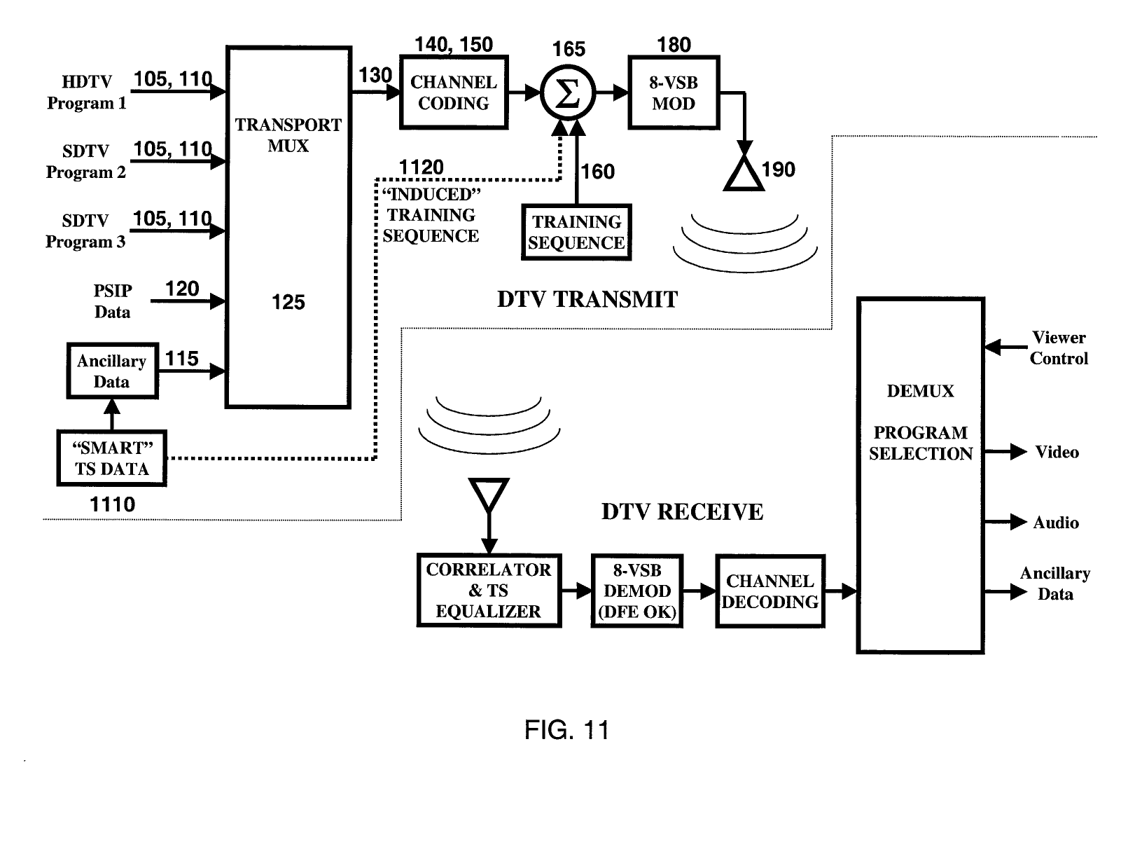

The present invention consists of a method of introducing new, more frequent training symbols into the modulation frame through backward compatible induction. FIG. 11 illustrates the necessary modifications to the ATSC DTV transmission and reception systems. In this method, “supplemental training sequence” data 1110 is introduced into the service multiplex 125 in the form of periodic packets 1110. Such packets are formed with the ATSC DTV standard in mind in such a manner as to induce frequent and advantageous training symbol components 1120 into the ATSC DTV modulation frame illustrated in FIG. 2.

The operation of the training symbol induction method is best described by example. In the first example, one training symbol packet is introduced into the service multiplex after every 12 conventional MPEG-2 service multiplex packet. The effective service rate is reduced by

$$\frac{1}{13} ≅ 8 \%$$

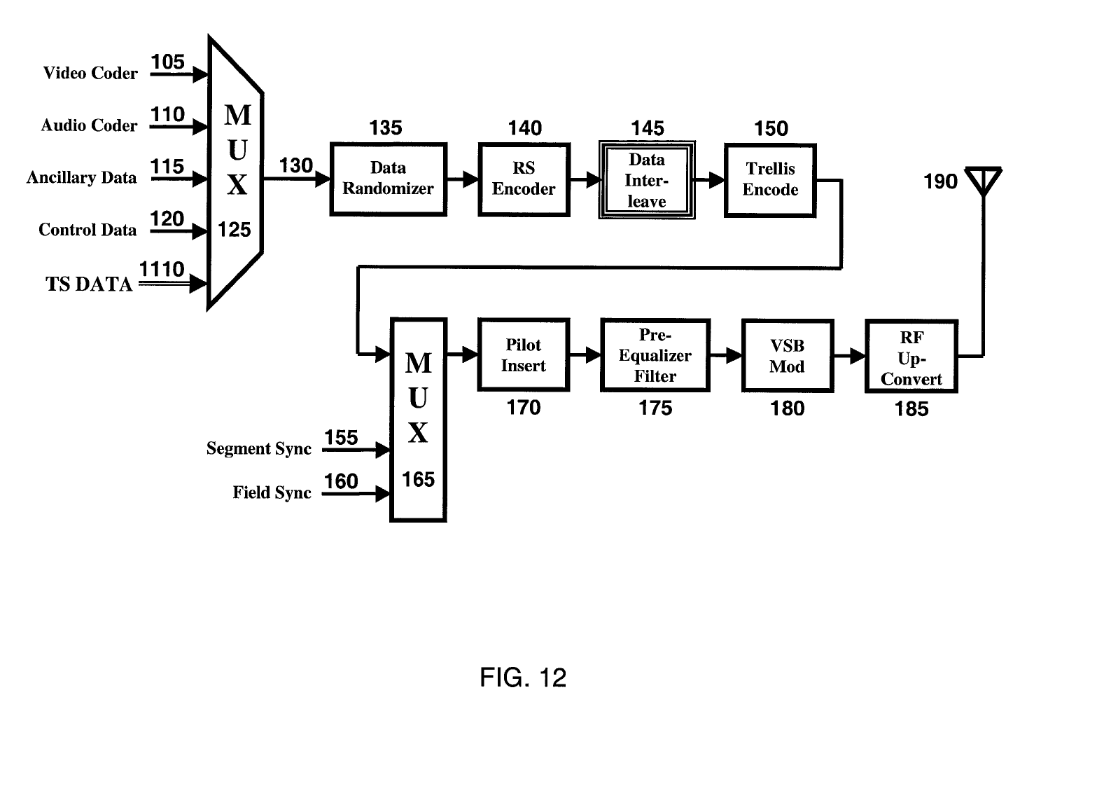

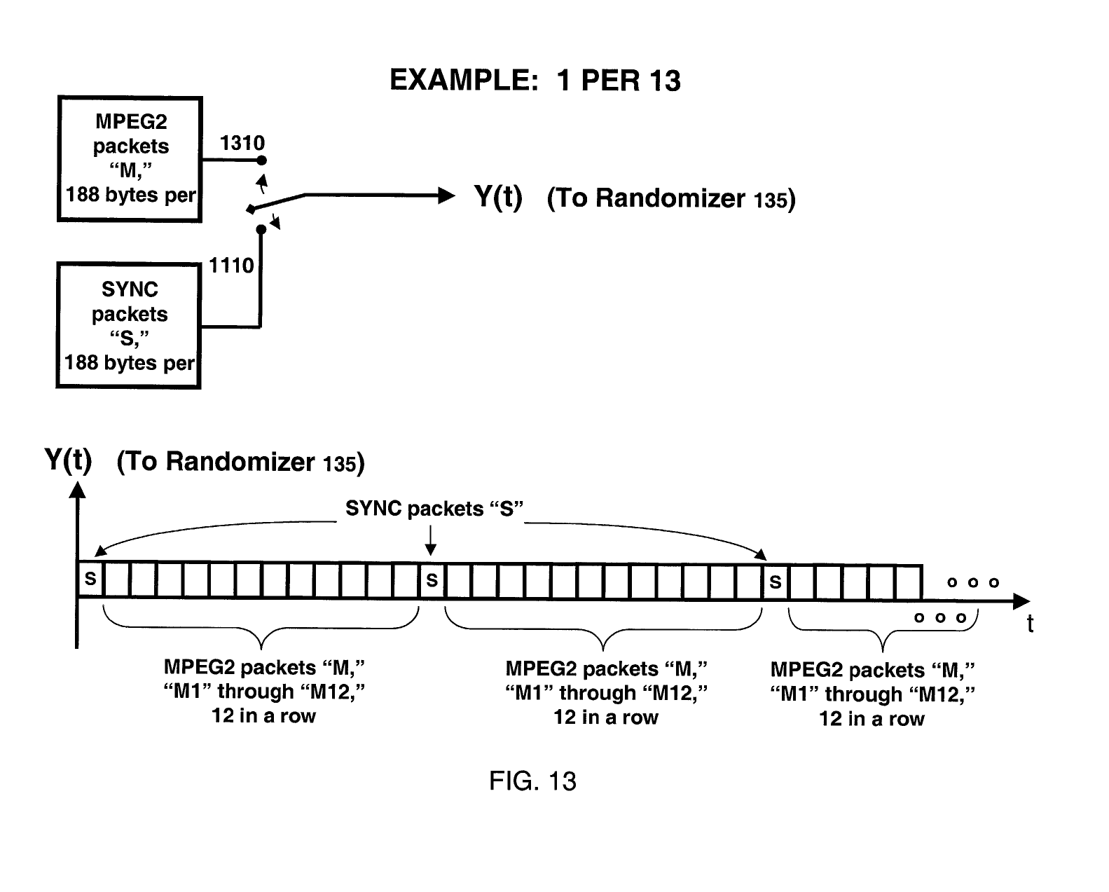

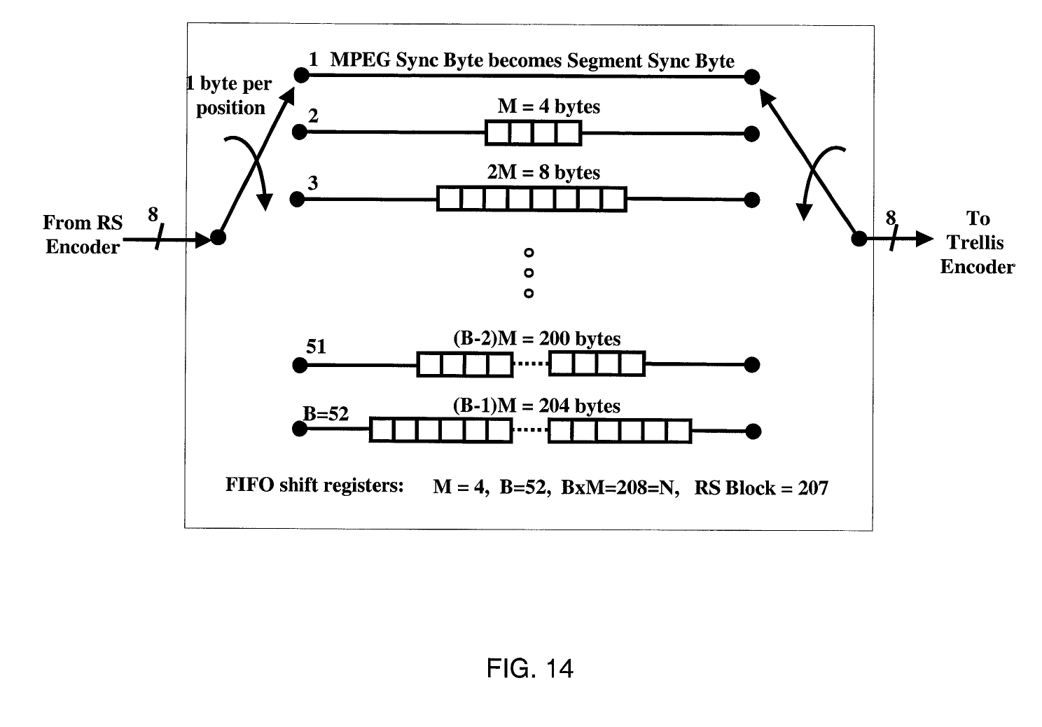

≈ 8% in the interest of inducing the advantageous frequent training symbol components. FIG. 12 emphasizes the introduction of the training symbol packet data 1110 and the subsequent interleave processing 145, inherent to ATSC-DTV standard transmission, which has the effect of distributing the induced training symbols throughout the modulation frame illustrated in FIG. 2. FIG. 13 illustrates the sequence of new supplemental training symbol packets 1110 and conventional MPEG-2 multiplex packets 1310 at the output of the service multiplexer 125. FIG. 14 illustrates the interleave process 145 i.a.w. the ATSC DTV standard.

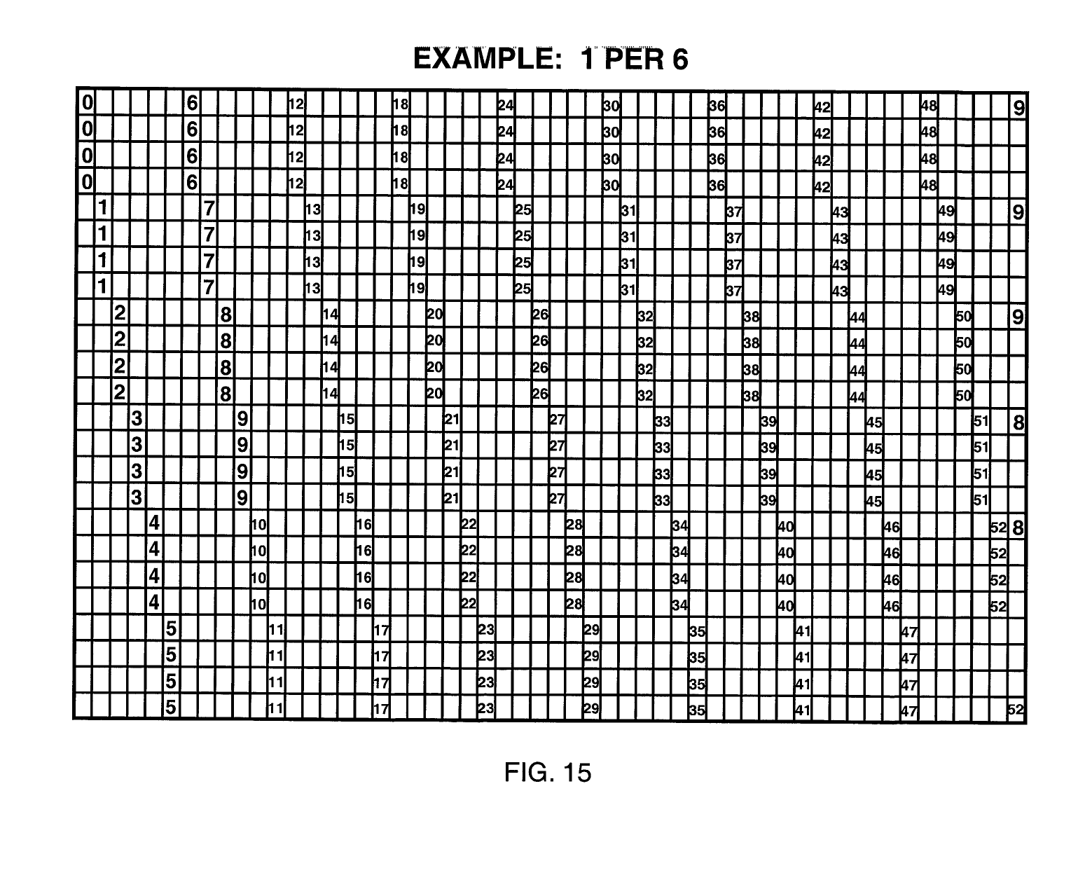

The distribution of MPEG-2 training symbol bytes by the interleaver 145 in the modulation frame (FIG. 2) is illustrated in FIG. 15 using an example where 1 training sequence packet is introduced per 5 conventional MPEG-2 data packets, or 6 total MPEG-2 packets. In this illustration, every box represents a byte of multiplexed data read left-to-right, then top-to-bottom. The numbered boxes indicate the positions of the post-interleave training symbol bytes i.a.w. the ATSC DTV standard byte interleave process 145. In this manner, each byte of each training sequence packet 1110 in the service multiplex 125 is mapped through the interleave process 145. Not shown is the addition 140 of Reed-Solomon (R/S) checkbytes to each service multiplex packet i.a.w. ATSC-DTV standard transmission practice.

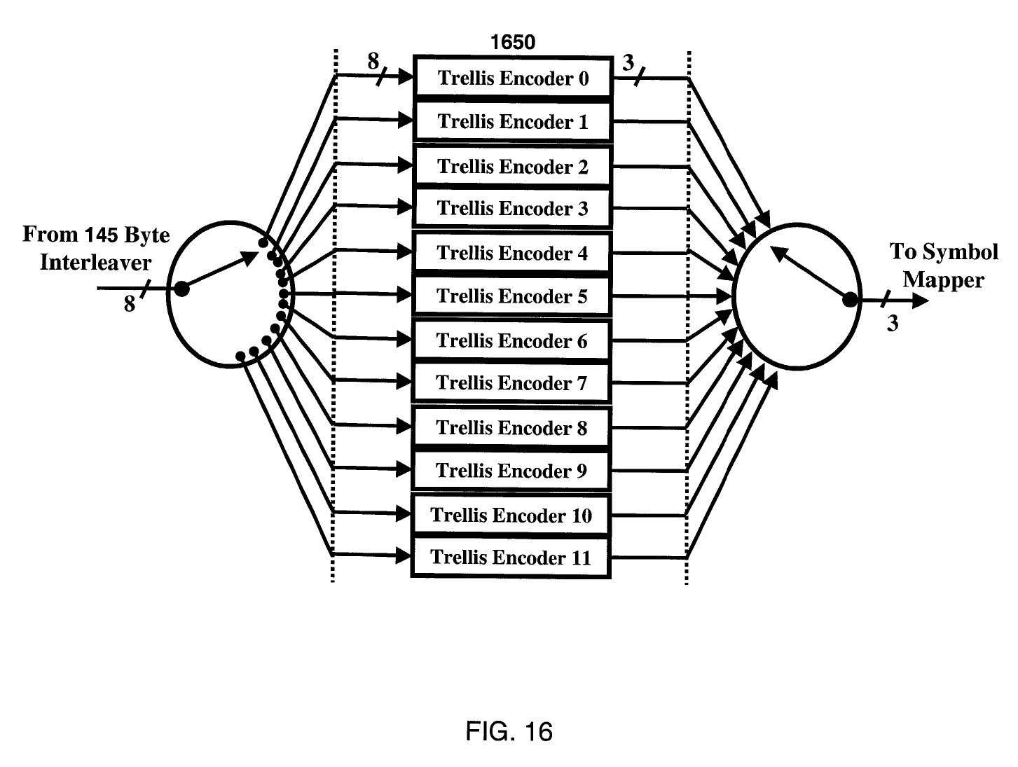

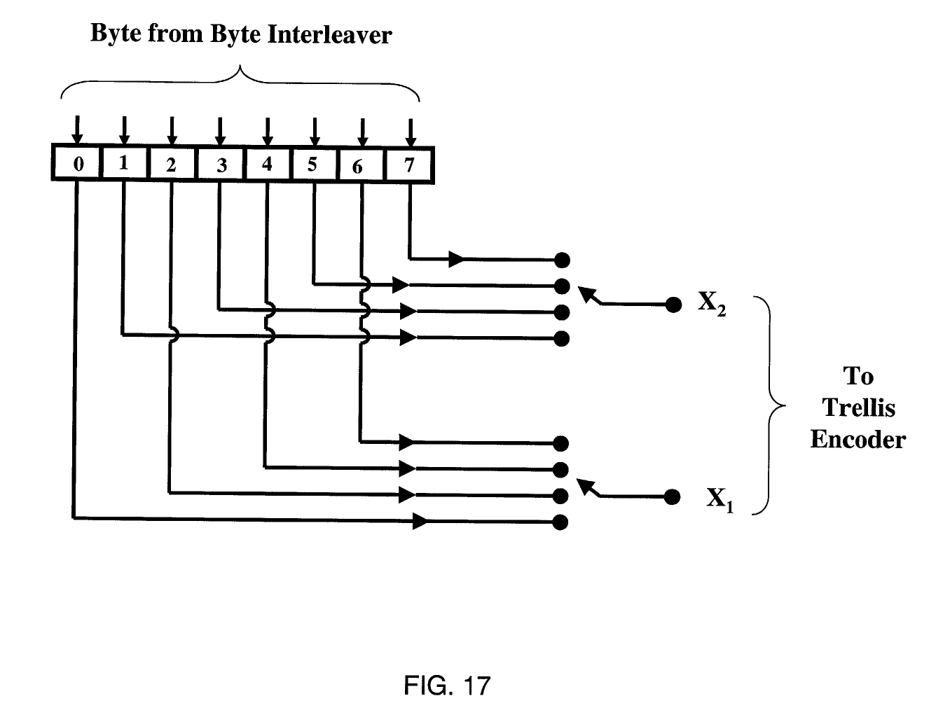

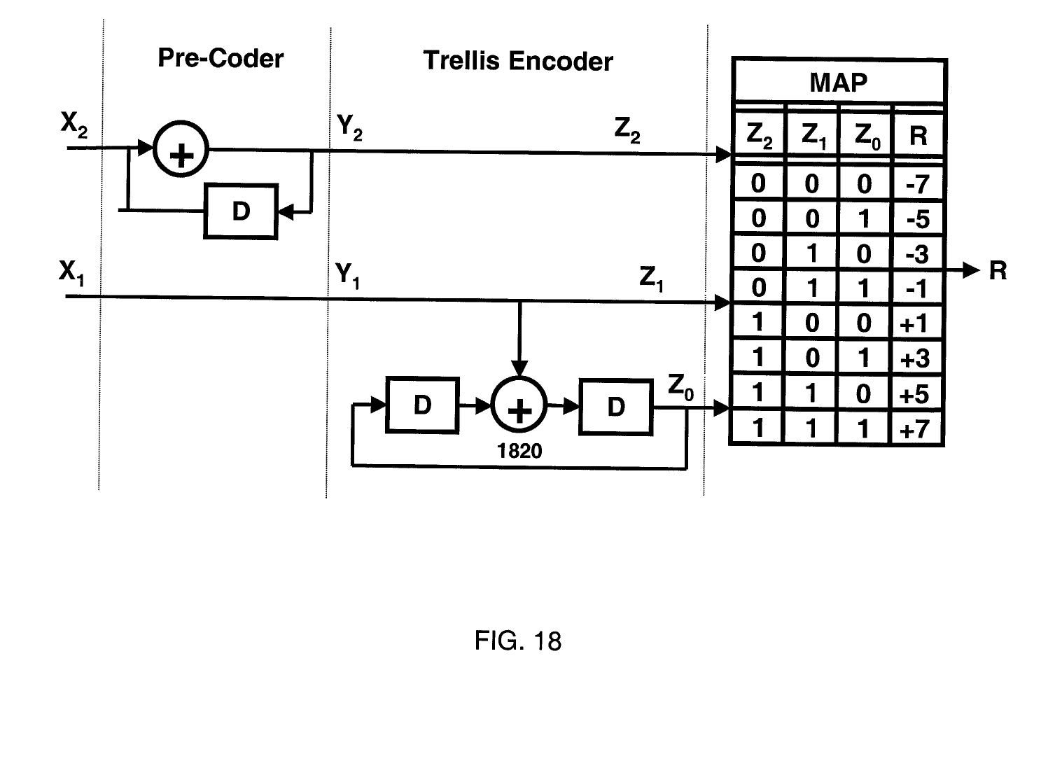

Subsequent ATSC-DTV standard processing is required before corresponding new supplemental training symbols 1120 are manifested into the DTV modulation frame (FIG. 2). The byte-interleaved service multiplex, which is the output of the byte interleaver 145, is applied to a TCM (trellis-coded modulation) byte interleaver as shown in FIG. 16. Each of the 12 parallel TCM encode processes 1650 involve bit interleaving as shown in FIG. 17 and TCM encoding as shown in FIG. 18. In the induction method disclosed, each induction data bit is mapped from the interleaved service multiplex data stream (output of byte interleaver 145) to the modulation frame (per ATSC Standard as illustrated in FIG. 2) in the same manner that the induction data packet bytes were mapped through the RIS encode process and subsequent byte interleave process into the interleaved service multiplex data stream (in the manner of FIG. 15).

The essence of this method is the exploitation of this mapping to induce frequent regular periodic training symbol components into the modulation frame so as to enable effective multipath reception at the compatible receiver while maintaining backwards-compatibility with pre-existing legacy reception equipment.

It is important that the training symbol components induced into the ATSC DTV modulation frame be of sufficient number and frequency as to enable effective multipath reception. Such frequency and number is determined by evaluating relevant propagation parameters.

The first relevant propagation parameter is the multipath delay spread. The relevant VHF and UHF multipath delay spreads are on the order of up to 100 μs. Another relevant propagation parameter is the highest transmission frequency. This frequency ƒₘₐₓ corresponds to the highest terrestrial broadcast television channel,

ƒ_{max ≅}800 MHz

The minimum transmission wavelength λₘᵢₙ is computed from the highest transmission frequency ƒₘₐₓ using

$$\begin{matrix}{λ}_{min} ≅ \frac{c}{{f}_{max}} \\ ≅ \frac{3 \times {10}^{8}}{800 \times {10}^{6}} \\ ≅ .375 m\end{matrix}$$

The maximum multipath reflection component velocity υₘₐₓis calculated in terms of maximum number of wavelengths per second from the 100 kph benchmark as follows.

$$\begin{matrix}{v}_{max} ≅ 2 \times 100 kph ≅ 200 kph \\ ≅ 200 kph \times \frac{1000 m}{km} \times \frac{1 hr}{3600 s} \times \frac{{λ}_{min}}{.375 m} \\ ≅ 150 \frac{{λ}_{min}}{s}\end{matrix}$$

The corresponding minimum multipath-ray phase-change or phase-rotation periodicity T_{reflection} is calculated from this υₘₐₓ using

$$\begin{matrix}{T}_{reflection} ≅ \frac{1}{150} \\ ≅ \frac{7 ms}{{λ}_{min}}\end{matrix}$$

Finally, experience indicates the prudence of offering provisions for updating multipath equalizers more than 10 times per minimum path variation cycle interval. Using instead a more conservative factor of 20, the recommended equalizer update interval is calculated to be

$$\begin{matrix}{T}_{update} ≅ \frac{7 ms}{{λ}_{min}} \times \frac{{λ}_{min}}{20 updates} \\ < 350 μs \\ {T}_{update} < 350 μs\end{matrix}$$

or

In summary, adequate ATSC DTV multipath equalization calls for equalization of delay spreads on the order of up to 100 μs at update intervals of less than 350 μs.

The preferred embodiment is derived from

1. the need to introduce training waveforms at intervals of less than 350 μs so that associated receivers can successfully track multipath using reliable reference-trained equalizers

2. the need to supply sufficient training symbols in each such training waveform so as to ensure the ability of trained equalizers to sufficiently train at the intervals indicated

3. the need to match training waveform periodicity with those of the pre-existing ATSC Standard

4. the need to keep the enhancement simple

5. the need to restrict the introduction of training symbols to a reasonably small percentage of the system data throughput so as to preserve information capacity

The preferred embodiment consists of the introduction of 4 induction packets per 52 multiplex packets. Periodicity is essential, as it is essential that the receiver be able to find the induced reference symbols. A periodicity of 52 multiplex packets is chosen because 52 multiplex packets divides evenly into the 624 multiplex packets which map into the ATSC DTV modulation frame and into the 12-branch TCM encode interleave process i.a.w. the ATSC DTV standard (52×12=624).

In the preferred embodiment, 4 induction packets per 52 service multiplex packets map into approximately 96 full training symbols per 3 modulation segments (232 μs) plus 96 partial training symbols. These second 96 “partial” training symbols are “partial” in the sense that their state cannot be fully controlled due to the two-bit delay 1820 inherent in the ATSC-DTV standard TCM encoding process, illustrated in FIG. 18. Their state may only be partially controlled in the sense that the bit which is not subject to convolutional coding delay is used to map the major component of the symbol state as opposed to the entire symbol state. The relevant correlation processing gain is approximated using

10 log (96×1.5)>20dB

offering greater than 20 dB processing gain with which to resolve the channel response.

As such, the preferred embodiment offers adequate and sufficiently frequent means to characterize multipath suitably for reliable ATSC DTV receiver channel characterization and demodulation, or to otherwise serve as a reference against which to train the corresponding equalizers.

Also crucial to the successful implementation of the training symbol induction method is the necessity to ensure compatibility of the induction packets with existing receivers. It is necessary that preexisting legacy receivers “reject” such packets. This is accomplished through one or both of the following techniques:

1. The induction process verifies or causes training symbol induction packets to be invalid and “uncorrectable” RJS codewords (distance>10 R/S characters to nearest valid codeword) so as to be discarded by the receiver

2. The induction process causes training symbol induction packets to be associated with an unused MPEG-2 program channel so as to be discarded by the receiver

The data overhead associated with either of these processes does not cause an appreciable degradation to the >20 dB processing gain associated with the preferred embodiment described above.

Of significance to the method disclosed is the fact that induced training symbols do not typically appear contiguously in the modulation frame, but are instead typically interspersed between data symbols. The result is that a longer time base is used to formulate each channel multipath approximation.

The preferred embodiment at the receiver is to employ a reference-trained equalizer such as the one illustrated in FIG. 8. Such an equalizer would exploit the sufficiently frequent training waveform and the a-priori knowledge of training symbol locations to find the training symbols and to train the equalizer against them. Measures to acquire and maintain symbol and modulation frame timing would be required.

An alternative reception method involves

1. Use of a correlator to determine a sufficiently accurate approximation

$$\hat{\overline{h}} ( n , m )$$

for the multipath channel response \overline{h}(n,m) 540 at every training waveform interval

2. Use of an LMS, RLS or other relevant technique to approximate the necessary inverse-channel function

$$\overline{{h}^{- 1}} ( n , m )$$

610 required in the implementation of the required equalizer

$$\hat{\overline{{h}^{- 1}}} ( n , m )$$

610

In terms of the correlator, an objection may be raised in terms of anticipated complexity. However, a very computationally efficient correlator is constructed as follows.

1. Whereas ATSC-DTV 8-VSB symbol states (−7, −5, −3, −1, 1, 3, 5 and 7) are offset i.a.w. the ATSC DTV standard by a pilot of magnitude “1.25,” the effective symbol states become (−5.75, −3.75, −1.75, 0.25, 2.25, 4.25, 6.25 and 8.25)

2. A reasonable and acceptable approximation to these states are the states (−6, −4, −2, 0, 2, 4, 6 and 8)

3. Correlation of a 96×2=192 symbol sequence involves 192 multiplies per point, which is extremely computationally intensive. However, the required multiplies, subject to the approximation above, may instead be implemented in fixed-point arithmetic using successive bit-shifts and adds (i.e. multiplication by 4 is a 2-bit shift; multiplication by 6 is the sum of the results of a 1-bit shift and a 2-bit shift). The resulting implementation significantly reduces computational burden.

4. A minor modification of the ATSC DTV standard consisting of a change in the pilot level from 1.25 to 1 renders the above approximation (step 2) exact

The preferred reception method involves the use of the correlator described above to acquire and maintain symbol and frame timing while employing the reference-trained equalization process of FIG. 8 to suppress multipath-induced intersymbol interference.

What is claimed is:

1. A method of introducing legacy-compatible supplemental training waveform components into ATSC-compatible DTV transmission waveforms by exploiting ancillary data capability in said standard.

2. A method of introducing said legacy-compatible supplemental training waveform components per claim 1 by anticipating transmission signal processing, and compensating for same, in the generation and queueing of relevant ancillary data packets so as to induce the designed training waveform components, while preserving enough information in relevant ancillary data packets so as to allow legacy and future receivers to distinguish these training waveform induction packets from desired information-bearing packets.

3. A method of introducing said legacy-compatible supplemental training waveform components per claim 1 at the transmission point by introducing appropriate “placeholder” packets in the packet data stream, then generating intentionally designed supplemental training waveform components in the modulation waveform at time instances corresponding to those which map from the “placeholder” training symbol induction packets while passing sufficient data, undisturbed, from same placeholder packets so as to cause legacy and future receivers to distinguish those placeholder packets from desired information-bearing packets.

4. A method of introducing zero, one or more selectable legacy-compatible supplemental training waveform components into ATSC-compatible DTV transmission waveforms per the method of claim 1, said training waveforms selected from a plurality or ensemble of selections, where each selection or combination of selections is identifiable to the receiver through signaling means available through spare capacity in the ATSC DTV field sync segment or otherwise.

5. A method of introducing zero, one or more selectable legacy-compatible supplemental training waveform components into ATSC-compatible DTV transmission waveforms per the method of claim 1, said training waveforms selected from a plurality or ensemble of selections, where each selection or combination of selections is identifiable to the receiver through signaling means available through information payload packets, or portions of information payload packets, designated for use as such.

6. A method of introducing zero, one or more selectable legacy-compatible supplemental training waveform components into ATSC-compatible DTV transmission waveforms per the method of claim 1, said training waveforms selected from a plurality or ensemble of selections, where each selection or combination of selections is identifiable to the receiver through its correlation properties.

7. A method of gradually improving multipath resilience of ATSC DTV standard broadcast and reception systems by gradually introducing, over time, various legacy-compatible supplementary training or reference waveforms for inclusion, selectably or otherwise, per the method of claim 1.

8. A method of designing legacy-compatible supplemental training waveform components for introduction per method of claim 1 so as to derive maximum benefit, with respect to equalization subject to known channel multipath characteristics, through appropriate selection of length, periodicity and processing gain of same said supplemental training waveform components, said selection subject to pre-existing ATSC DTV transmission signal periodicities and configuration.

9. A method of exploiting, at the receiver, said legacy-compatible supplemental training waveform components introduced per method of claim 1 by employing those components to more quickly, frequently and/or reliably train pre-demodulation equalizers.

10. A method of exploiting, at the receiver, said legacy-compatible supplemental training waveform components introduced per method of claim 1 by passing the received transmission waveform through a correlator, digital or otherwise, to extract multipath channel response characteristics for use in more quickly, frequently and/or reliably training pre-demodulation equalizers.

11. A method of exploiting, at the receiver, said legacy-compatible supplemental training waveform components introduced per method of claim 1 by passing the received transmission waveform through a digital correlator, said correlator implemented with reduced complexity based on the use of bit shifts and sign changes instead of multiplication, yielding a correlator implementation limited to addition operations or to addition operations and a minimum number of bit shifts, and said correlation process for the purpose of extracting multipath channel response characteristics for use in more quickly, frequently and/or reliably training pre-demodulation equalizers.

12. The method of modifying the ATSC DTV standard transmission format by reducing pilot signal amplitude by 20% in the interest of subsequently reducing computational complexity required of correlation-based training-waveform processing, or in the interest of improving the accuracy of said reduced-complexity correlators over the accuracy possible with the presently specified pilot amplitude.

13. A method of introducing legacy-compatible supplemental training waveform components into digital transmissions in general by exploiting packet-based information payloads.

14. A method of introducing said legacy-compatible supplemental training waveform components per claim 13 by anticipating transmission signal processing, and compensating for same, in the generation and queueing of relevant ancillary data packets so as to induce the intentionally designed training waveform components while preserving enough information in relevant ancillary data packets so as to allow legacy and future receivers to distinguish these training waveform induction packets from desired information-bearing packets.

15. A method of introducing said legacy-compatible supplemental training waveform components per claim 13 at the transmission point by introducing appropriate “placeholder” packets in the packet data stream, then generating designed supplemental training waveform components in the modulation waveform at time instances corresponding to those which map from the “placeholder” training symbol induction packets while passing sufficient data, undisturbed, from same placeholder packets so as to cause legacy and future receivers to distinguish those placeholder packets from desired information-bearing packets.

16. A method of introducing zero, one or more selectable legacy-compatible supplemental training waveform components into digital transmission waveforms per the method of claim 13, said training waveforms selected from a plurality or ensemble of selections, where each selection or combination of selections is identifiable to the receiver through signaling means available through spare capacity in the modulation fields designed to convey configuration and control overhead information.

17. A method of introducing zero, one or more selectable legacy-compatible supplemental training waveform components into digital transmission waveforms ATSC-compatible DTV transmission waveforms per the method of claim 13, said training waveforms selected from a plurality or ensemble of selections, where each selection or combination of selections is identifiable to the receiver through signaling means available through information payload packets, or portions of information payload packets, designated for use as such.

18. A method of introducing zero, one or more selectable legacy-compatible supplemental training waveform components into digital transmission waveforms per the method of claim 13, said training waveforms selected from a plurality or ensemble of selections, where each selection or combination of selections is identifiable to the receiver through new signaling means introduced into the legacy modulation waveform.

19. A method of introducing zero, one or more selectable legacy-compatible supplemental training waveform components into digital transmission waveforms ATSC-compatible DTV transmission waveforms per the method of claim 13, said training waveforms selected from a plurality or ensemble of selections, where each selection or combination of selections is identifiable to the receiver through signaling means available through newly configured information payload packets, or new portions of legacy standard information payload packets, introduced for use as such.

20. A method of introducing zero, one or more selectable legacy-compatible supplemental training waveform components into ATSC-compatible DTV transmission waveforms per the method of claim 13, said training waveforms selected from a plurality or ensemble of selections, where each selection or combination of selections is identifiable to the receiver through its correlation properties.

21. A method of designing legacy-compatible supplemental training waveform components for introduction per method of claim 13 so as to derive maximum benefit, with respect to equalization subject to known channel multipath characteristics, through appropriate selection of length, periodicity and processing gain of same said supplemental training waveform components, said selection subject to pre-existing digital transmission signal periodicities and configuration and to payload packet periodicities and configuration.

22. A method of exploiting, at the receiver, said legacy-compatible supplemental training waveform components introduced per method of claim 13 by employing those components to more quickly, frequently and/or reliably train pre-demodulation equalizers.

23. A method of exploiting, at the receiver, said legacy-compatible supplemental training waveform components introduced per method of claim 13 by passing the received transmission waveform through a correlator, digital or otherwise, to extract multipath channel response characteristics for use in more quickly, frequently and/or reliably training pre-demodulation equalizers.

24. A method of exploiting, at the receiver, said legacy-compatible supplemental training waveform components introduced per method of claim 13 by passing the received transmission waveform through a digital correlator, said correlator implemented with reduced complexity based on the use of bit shifts and sign changes instead of multiplication, yielding a correlator implementation limited to addition operations or to addition operations and a minimum number of bit shifts, and said correlation process for the purpose of extracting multipath channel response characteristics for use in more quickly, frequently and/or reliably training pre-demodulation equalizers.
